(19) United States
(12) Patent Application Publication
(10) Pub. No.: US 2016/0289529 A1
(43) Pub. Date: Oct. 6, 2016

(54) LUBRICANT ADDITIVES FOR WELL-BORE OR SUBTERRANEAN DRILLING FLUIDS OR MUDS

(71) Applicant: Duong Nguyen, Dover, OH (US)

(72) Inventor: Duong Nguyen, Dover, OH (US)

(73) Assignee: Dover Chemical Corporation, Dover, OH (US)

(21) Appl. No.: 15/083,969

(22) Filed: Mar. 29, 2016

Related U.S. Application Data
(60) Provisional application No. 62/168,687, filed on May 29, 2015.
(60) Provisional application No. 62/140,964, filed on Mar. 31, 2015.

(51) Int. Cl. C09K 8/035; C09K 8/06

(52) U.S. Cl. CPC C09K 8/035; C09K 8/06; C09K 2208/34

(57) ABSTRACT

A composition having a three-component blend, wherein the first component is a sulfurized additive; wherein the second component is an oleic-acid ester or tall-oil fatty-acid ester; and wherein the third component includes an ethoxylated fatty ester.

### CROSS-REFERENCE TO RELATED APPLICATIONS

This patent application claims priority to both of the following U.S. provisional patent applications: U.S. provisional patent application No. 62/168,687 filed on May 29, 2015; and U.S. provisional patent application No. 62/140,964 filed on Mar. 31, 2015.

The subject matter of both provisional patent applications is hereby incorporated by reference.

### BACKGROUND OF THE INVENTION

During drilling operations for oil-and gas explorations, a drilling fluid or mud is typically circulated through the well-bore to increase drilling efficiencies. Drilling mud serves as a fluid medium for transporting the generated cuttings or debris out of the well-bore. Drilling mud serves the additional function of helping to stabilize the well-bore formation, preventing it from collapse because of the mud's hydrostatic pressure exerted on the well-bore wall; in other words, it helps to maintain the well-bore wall integrity.

Drilling muds (or fluids) improve drilling efficiency by lubricating the rotary-drill bits that are located at the end of drill pipe string, and also by lubricating the drill pipe string that can stick or rub against the borehole causing undesirable increased friction, energy loss, misdirection of the drilling, and eventually slowing the drilling process.

Drilling muds can be categorized according to their base: water-based muds (WBM) or oil-based muds (OBM). WBM typically include bentonite clay or polymeric (solids-free) thickeners to suspend or thicken the aqueous continuous phase that can be derived from fresh water or salt solutions (or brines) as in brine muds (BRM). OBM or invert-emulsion water-in-oil mud includes from 50:50 to 95:5 blend ratios of oil to water in which oil is the continuous phase. The continuous hydrocarbon phase in OBM can be diesel, mineral oil, natural vegetable oils, synthetic esters, or olefins.

In addition to their respective base, commonly used components of both WBM and OBM include:
a. Bentonite clay thickener for WBM or organophilic clay for OBM
b. Fluid-loss reducers or filtrate reducers that are typically water-dispersible polymers designed to stop the water component of a mud from penetrating into the drier surroundings of a well bore or vice versa, i.e., to stop subterranean water from penetrating into the well bore or newly-drilled formation by softening and collapsing it; these additives are also used to prevent water from diffusing into the drilling mud and altering its physical characteristics and therefore its designed functions. Illustrative and non-limiting examples of these additives are Baker Hughes' Xanplex® D or xanthan gum, Drilling Specialties Company's Drispac® Superflow or polyanionic cellulosic polymer, and Baker Hughes' Bio-Lose® or non-fermented chemically modified starch.
c. Thinners or deflocculants, a non-limiting exemplary list including Drilling Specialties' s Desco® deflocculant, which is a tannin-based thinner.
d. Barite or barium sulfate, one of the more effective weighting materials used to increase a drilling-mud density, and consequently, to improve a drilling mud's effective underground hydrostatic pressure.
e. Rev-Dust®, manufactured by Milwhite Inc.; an abrasive calcium montmorillonite commonly used to simulate effects of reactive drilled solids or cuttings.
f. pH adjusters and other inorganic components such as sodium hydroxide or caustic, sodium chloride salt, lime, hydrated calcium chloride in brine, potassium silicate such as PQ Corporation's Kasil-1, which is 30% potassium silicate solution.
g. Amine or sodium alkylated sulfonates that are used as water-in-oil emulsifiers in OBM formulas. Regarding examples contained later in this application, this component has been excluded to isolate the lubricity of the novel additive alone (without taking into the beneficial or synergistic effect of a sulfonate emulsifier).
h. Useful lubricants can be fatty acids, fatty amides and esters, phosphates, sulfurized and/or chlorinated hydrocarbons—lubricants are added into drilling fluids to reduce friction or torque, and consequently, to increase the drilling rate with less energy and time being consumed - fatty esters and amides also have a significant advantage by being renewable, non-toxic, biodegradable, and environmentally friendly friction reducers.

Some exemplary patent references dealing with using fatty esters as a lubricant in drilling muds are taught in U.S. Pat. No. 4,964,615; U.S. Pat. No. 5,318,956; U.S. Pat. No. 5,618,780; published United States Patent Application publication 2010/0305009 A1; and published PCT Patent Application WO 2011/019722 A2.

Some waste generated in oil-gas exploration is deep-underground water coming up to the surface along with crude oil and wet gases. The ratio of barrels of produced crude and produced water can be as high as seventy to one. This water can be extremely high in salts, close to 30% by weight, in which calcium mineral or water hardness is most troublesome to conventional drilling fluids as it tends to coagulate or flocculate organic components of a drilling fluid such as fatty esters and soaps. This waste needs to be disposed of properly and the industry desires to utilize a small portion (10-20%) of it as base carrier for brine drilling muds instead of using fresh water. To be able to put heavy-brine or produced water into a good use, an effective lubricant needs to be developed as the brine is quite abrasive to drill bits. But the calcium salts in heavy-brine make it very difficult for known lubricants to be used due to the flocculation effect or “grease-out” especially at high temperatures.

Very generally, a drilling-mud lubricant or additive is introduced into a drilling mud to improve the drilling mud's overall effectiveness, fluid-flow, and performance metrics. Dispersibility, stability, and flocculation are non-limiting examples of drilling-mud lubricant physical properties used to qualify a lubricant's effectiveness.

Dispersibility is commonly defined as the ease with which a lubricant can be dispersed within a fluid medium. A lubricant with good dispersibility will take less time and agitation to homogenize throughout the fluid medium. Good dispersibility in a water or a brine-based system decreases the chances that the lubricant particles will aggregate together and cease to be homogenized in the system. When this happens, the lubricant essentially loses effectiveness by coming out of solution and will also likely float on top of the medium. This is referred to in the industry as “cheesing out.” Most lubricants will do this given enough time, especially in the absence of agitation.

Stability is an indication of how long a lubricant stays dispersed in a fluid medium. A lubricant with good stability will not separate quickly from the medium after being dispersed. Better stability means a relatively longer time before the lubricant “cheeses out.”

When discussing flocculation relative to a drilling-field lubricant, what is being referred to is the lubricant's affinity to the colloidal solids within the system, i.e., the lubricant's tendency to stick to the colloidal solids rather than dispersing homogeneously within a fluid medium. This is a serious problem in a closed-loop system where the colloidal solids are filtered out of the mud so that the mud can be re-circulated through the system. If the lubricant preferentially sticks to the solids rather than staying dispersed, the lubricant will be filtered off with the solids; and as a result, the mud will return to the system without the lubricant.

There remains a need for drilling-mud lubricants.

### BRIEF SUMMARY OF THE INVENTION

A composition having a three-component blend, wherein the first component is a sulfurized additive; wherein the second component is an oleic-acid ester or tall-oil fatty-acid ester; and wherein the third component includes an ethoxylated fatty ester.

A composition having a three-component blend having a pour point of about 5° C., wherein the first component is sulfurized methyl oleate that is about 10% sulfur by weight; wherein the second component is a mixture of tetra-oleates of pentaerythritol and tri-oleates of tri-ethanolamine; and wherein the third component is polyethylene glycol tallate.

A composition having a four-component blend, wherein the first component is sulfurized ethyl hexyl oleate that is about 10% sulfur by weight; wherein the second component is a mixture of trioleates of trimethylolpropane and tri-ethanolamine; wherein the third component is polypropylene glycol oleate; and wherein the fourth component is dioleate esters of ethoxylated castor oil.

At least some performance characteristics of a multi-component lubricant blend are related to its physical properties within any water-based system, including Bakken brine. Lubricant embodiments are specifically engineered to have superior dispersibility and stability, while minimizing flocculation. These properties give the multi-component lubricant embodiments a distinct advantage in water-based or brine-based systems, especially those that are closed-loop systems.

### DETAILED DESCRIPTION OF THE INVENTION

Embodiments are directed to a multi-component lubricant blend that is useful as a lubricant additive, friction reducer, or rate-of-penetration (ROP) enhancer for well-bore or subterranean oil-and-gas drilling. When added to a drilling mud, the multi-component lubricant blend provides beneficial drilling conditions.

Embodiments are directed to using the multi-component lubricant blend in a water-based drilling mud. Water-based drilling muds include water-containing muds, brine-containing muds, and Bakken-brine containing muds.

For the purposes of this application, the terms “% by weight” and “weight %” have the same meaning and are calculated as follows: [(weight of a part)/(weight of the whole)]×100%.

The multi-component lubricant blend can have any number of components, and non-limiting embodiments are directed to both three-component and four-component lubricant blends.

Three-component lubricant-blend embodiments include: a first component that is a sulfurized additive, a second component that includes an oleic-acid ester or tall-oil fatty-acid ester; and a third component that includes an ethoxylated fatty ester.

The first component (of a three-component lubricant-blend embodiment) can be selected from the following sulfurized additives or combinations thereof: 10% S sulfurized methyl fatty esters; 10% S sulfurized 2-ethylhexyl fatty esters; or 10% S sulfurized 2-ethylhexyl oleate (SEHO). Fatty esters can be oleate, tallate, castor fatty esters, or conceivably any sulfurized fatty esters derived from a Fisher esterification between alkyl alcohols and unsaturated fatty acids such as oleic acid, tall-oil fatty acid, castor oil fatty acid, or their blends. In embodiments, the above-described weight percents of sulfur (i.e., 10% by weight sulfur) can range from 5-20% by weight sulfur based on the weight of the final sulfurized fatty esters.

The second component (of a three-component lubricant-blend embodiment) can be selected from the following list of oleic-acid esters, tall-oil fatty-acid esters, or combinations thereof. In embodiments, a secondary emulsifier or coupler portion is the esters of oleic acid or tall-oil fatty acid synthesized via a Fisher esterification with alkanolamines (such as triethanolamine) and polyols (such as pentaerithrytol or trimethylolpropane) at various molar ratios. A molar composition of charges is one mole of oleic acid or fatty acid, half molar equivalent of pentaerythritol, and half molar equivalents of triethanolamine. Other alkanolamines besides triethanolamine can be used such as tris-isopropanolamine or diethanolamine or monoethanolamine. Other polyols can also be used in place of pentaerythritol or trimethylolpropane such as neopentyl glycol, glycerine, di-pentaerythritol, and various alkylated glycols.

In embodiments, any of the following combinations can be used as a second component (of a three-component lubricant blend):
i) the combination of an oleic-acid ester, a triethanolamine, and a pentaerithrytol;
ii) the combination of a tall-oil fatty-acid ester, a triethanolamine, and a pentaerithrytol;
iii) the combination of an oleic-acid ester, a triethanolamine, and a trimethylolpropane;
iv) the combination of a tall-oil fatty-acid ester, a triethanolamine, and a trimethylolpropane;
v) the combination of an oleic-acid ester, a tris-isopropanolamine, and a pentaerithrytol;
vi) the combination of a tall-oil fatty-acid ester, a tris-isopropanolamine, and a pentaerithrytol;
vii) the combination of an oleic-acid ester, a tris-isopropanolamine, and a trimethylolpropane;
viii) the combination of a tall-oil fatty-acid ester, a tris-isopropanolamine, and a trimethylolpropane;
ix) the combination of an oleic-acid ester, a diethanolamine, and a pentaerithrytol;
x) the combination of a tall-oil fatty-acid ester, a diethanolamine, and a pentaerithrytol;
xi) the combination of an oleic-acid ester, a diethanolamine, and a trimethylolpropane;
xii) the combination of a tall-oil fatty-acid ester, a diethanolamine, and a trimethylolpropane;
xiii) the combination of an oleic-acid ester, a monoethanolamine, and a pentaerithrytol;
xiv) the combination of a tall-oil fatty-acid ester, a monoethanolamine, and a pentaerithrytol;
xv) the combination of an oleic-acid ester, a monoethanolamine, and a trimethylolpropane;
xvi) the combination of a tall-oil fatty-acid ester, a monoethanolamine, and a trimethylolpropane;
xvii) the combination of an oleic-acid ester, a triethanolamine, and a neopentyl glycol;
xviii) the combination of a tall-oil fatty-acid ester, a triethanolamine, and a neopentyl glycol;
xix) the combination of an oleic-acid ester, a triethanolamine, and a glycerine;
xx) the combination of a tall-oil fatty-acid ester, a triethanolamine, and a glycerine;
xxi) the combination of an oleic-acid ester, a tris-isopropanolamine, and a neopentyl glycol;
xxii) the combination of a tall-oil fatty-acid ester, a tris-isopropanolamine, and a neopentyl glycol;
xxiii) the combination of an oleic-acid ester, a tris-isopropanolamine, and a glycerine;
xxiv) the combination of a tall-oil fatty-acid ester, a tris-isopropanolamine, and a glycerine;
xxv) the combination of an oleic-acid ester, a diethanolamine, and a neopentyl glycol;
xxvi) the combination of a tall-oil fatty-acid ester, a diethanolamine, and a neopentyl glycol;
xxvii) the combination of an oleic-acid ester, a diethanolamine, and a glycerine;
xxviii) the combination of a tall-oil fatty-acid ester, a diethanolamine, and a glycerine;
xxix) the combination of an oleic-acid ester, a monoethanolamine, and a neopentyl glycol;
xxx) the combination of a tall-oil fatty-acid ester, a monoethanolamine, and a neopentyl glycol;
xxxi) the combination of an oleic-acid ester, a monoethanolamine, and a glycerine;
xxxii) the combination of a tall-oil fatty-acid ester, a monoethanolamine, and a glycerinethe combination of an oleic-acid ester, a triethanolamine, and a di-pentaerythritol;
xxxiii) the combination of a tall-oil fatty-acid ester, a triethanolamine, and a di-pentaerythritol;
xxxiv) the combination of an oleic-acid ester, a triethanolamine, and a glycol;
xxxv) the combination of a tall-oil fatty-acid ester, a triethanolamine, and a glycol;
xxxvi) the combination of an oleic-acid ester, a tris-isopropanolamine, and a di-pentaerythritol;
xxxvii) the combination of a tall-oil fatty-acid ester, a tris-isopropanolamine, and a di-pentaerythritol;
xxxviii) the combination of an oleic-acid ester, a tris-isopropanolamine, and a glycol;
xxxix) the combination of a tall-oil fatty-acid ester, a tris-isopropanolamine, and a glycol;
xl) the combination of an oleic-acid ester, a diethanolamine, and a di-pentaerythritol;
xli) the combination of a tall-oil fatty-acid ester, a diethanolamine, and a di-pentaerythritol;
xlii) the combination of an oleic-acid ester, a diethanolamine, and a glycol;
xliii) the combination of a tall-oil fatty-acid ester, a diethanolamine, and a glycol;
xliv) the combination of an oleic-acid ester, a monoethanolamine, and a di-pentaerythritol;
xlv) the combination of a tall-oil fatty-acid ester, a monoethanolamine, and a di-pentaerythritol;
xlvi) the combination of an oleic-acid ester, a monoethanolamine, and a glycol; and
xlvii) the combination of a tall-oil fatty-acid ester, a monoethanolamine, and a glycol.

The third component (of a three-component lubricant-blend embodiment) can be selected from the following list of ethoxylated fatty esters or combinations thereof: ethoxylated fatty esters such as polyethylene glycol (MW=200-600) esters of oleic acid or of tall-oil fatty acid; Dover Chemical Corporation's DFA-600™ (which is a polyol fatty ester) by itself or its blend with polypropylene glycol esters of a fatty acid and other ethoxylated emulsifiers such as Milliken Chemical's Synlube 728™ (which is ethoxylated castor oil di-oleates).

In embodiments, the first component is present within the three-component blend at about 60% by weight of the three-component blend. In other embodiments, the first component is present within the three-component blend at about 40% by weight of the three-component blend. In still other embodiments, the first component is present within the three-component blend at a percentage ranging from about 40% to about 60% by weight of the three-component blend.

In embodiments, the second component is present within the three-component blend at about 20% by weight of the three-component blend. In other embodiments, the second component is present within the three-component blend at about 30% by weight of the three-component blend. In still other embodiments, the second component is present within the three-component blend at a percentage ranging from about 20% to about 30% by weight of the three-component blend.

In embodiments, the third component is present within the three-component blend at about 20% by weight of the three-component blend. In other embodiments, the third component is present within the three-component blend at about 30% by weight of the three-component blend. In still other embodiments, the third component is present within the three-component blend at a percentage ranging from about 20% to about 30% by weight of the three-component blend.

In an embodiment, a useful three-component lubricant blend having a pour point of 5° C. is:
40% 10% S Sulfurized methyl oleate;
30% mixture of tetra-oleates of pentaerythritol and tri-oleates of triethanolamine; and
30% polyethylene glycol (MW=600) tallate.

Persons of ordinary skill in the art will be able to determine useful amounts of the three-component lubricant blend to be used in association with a water-based or brine-based drilling mud. Useful amounts of the three-component blend range from 0.1 weight % to 10 weight % based on total weight of drilling fluids/mud. Additional useful amounts of the three-component blend range from 1 weight % to 3 weight % based on total weight of drilling fluids/mud. An additional useful amount of the three-component blend is 2 weight % based on total weight of drilling fluids/mud.

In embodiments, three-component lubricant-blend embodiments have a pour point of 5° C. In other embodiments, three-component lubricant-blend embodiments have a pour point at least as low as 5° C.

Four-component lubricant-blend embodiments include: a first component that is sulfurized ethyl hexyl oleate that is about 10% sulfur by weight; a second component that is a mixture of trioleates of trimethylolpropane and tri-ethanolamine; a third component that is polypropylene glycol oleate; and a fourth component that is a dioleate ester of ethoxylated castor oil.

The first component (of a four-component lubricant-blend embodiment) can be selected from sulfurized ethyl hexyl oleates that are respectively about 10% sulfur by weight or combinations thereof. In embodiments, ethyl hexyl oleate can be substituted with any fatty ester made from: i) a fatty acid such as oleic acid, tall oil fatty acid, dimer acid, or castor oil fatty acid, and ii) a branched secondary or tertiary alcohol such as trimethylolpropane, neopentyl alcohol, isooctanol, and isotridecanol.

The second component (of a four-component lubricant-blend embodiment) can be selected from mixtures of trioleates of trimethylolpropane and tri-ethanolamine, or combinations thereof. Mixtures of trioleates of trimethylolpropane and tri-ethanolamine can be substituted with any fatty-ester combinations made from one or more of alkanolamines, one or more of polyols, and one or more of fatty acids such as oleic acid, tall oil fatty acid, dimer acid, or castor oil fatty acid.

The third component (of a four-component lubricant-blend embodiment) can be selected from polypropylene glycol oleates or tallate or combinations thereof.

The fourth component (of a four-component lubricant-blend embodiment) can be selected from dioleate esters of ethoxylated castor oil or combinations thereof. In embodiments, fatty esters of ethoxylated propoxylated copolymers with equivalent HLB values to Syn Lube™ 728, meaning 4-12, can be used as a substitute for dioleate esters of ethoxylated castor oil.

In embodiments, the first component is present within the four-component blend at about 40% by weight of the four-component blend. In other embodiments, the first component is present within the four-component blend at a percentage ranging from about 30% to about 40% by weight of the four-component blend.

In embodiments, the second component is present within the four-component blend at about 30% by weight of the four-component blend. In other embodiments, the second component is present within the four-component blend at a percentage ranging from about 20% to about 40% by weight of the four-component blend.

In embodiments, the third component is present within the four-component blend at about 21% by weight of the four-component blend. In other embodiments, the third component is present within the four-component blend at a percentage ranging from about 10% to about 30% by weight of the four-component blend.

In embodiments, the fourth component is present within the four-component blend at about 9% by weight of the four-component blend. In other embodiments, the fourth component is present within the four-component blend at a percentage ranging from about 5% to about 15% by weight of the four-component blend.

In an embodiment, a useful four-component lubricant blend having a pour point of about −20° C. is:
40% 10% S Sulfurized 2-Ethyl hexyl oleate;
30% Tri-oleates of trimethylolpropane and triethanolamine;
21% Polypropylene glycol (MW=450) monotallate; and
09% Milliken's Synlube 728 or ethoxylated castor oil esters.

Persons of ordinary skill in the art will be able to determine useful amounts of the four-component lubricant blend to be used in association with a water-based or brine-based drilling mud. Useful amounts of the four-component blend range from 0.1 weight % to 10 weight % based on total weight of drilling fluids/mud. Additional useful amounts of the four-component blend range from 1 weight % to 3 weight % based on total weight of drilling fluids/mud. An additional useful amount of the four-component blend is 2 weight % based on total weight of drilling fluids/mud.

In embodiments, four-component lubricant-blend embodiments have a pour point of −20° C. In other embodiments, four-component lubricant-blend embodiments have a pour point of at least as low as −20° C.

Embodiments are directed to a multi-component lubricant blend that is useful in subterranean-drilling-mud applications. Additional useful applications for the multi-component lubricant blend include: rotary drilling mud, coiled-tubing drilling mud, completion fluid/mud, work-over fluid/mud or general mud-containing fluid that is made with heavy brine.

### EXAMPLES

Synthetic Methods or Descriptions of The Lubricant Components:

10% S Sulfurized methyl oleate:

90 g of methyl oleate and 10 g sulfur flour were charged into an enclosed flask with nitrogen sparging to sweep of residual byproduct which exists throughout the sulfurization at 185° C. The batch was heated to and maintained at 185° C. for two hours with small exotherms and was cooled to 100° C. to air blow out all residual hydrogen sulfide by product.

Mixture of tetra-oleates of pentaerythritol and tri-oleates of triethanolamine:

One mole or 285 g oleic acid, half molar equivalent or 17 g (0.125 mole or 0.5 molar equivalent) of pentaerythritol, and one half molar equivalent or 25 g (0.167 mole or 0.5 molar equivalent) of triethanolamine, were charged together with 0.3% or 1.0 g methane sulfonic acid (MSA) as a catalyst for Fisher esterification. The esterification was carried out at 175C under moderate nitrogen gas flow to sweep off water as a by-product until the acid number of about 10-30 mg KOH per gram is reached.

Polyethylene glycol (MW=600) tallate:

300 g (0.5 mole or 1.0 molar equivalent) polyethylene glycol (MW=600), 285 g (1.0 mole) tall oil fatty acid, and 6.0 g (1 wt. %) methane sulfonic acid were charged and cooked at 175° C. under a nitrogen sweep till the acid number of 10-30 mg KOH per gram of sample was reached.

10% S Sulfurized 2-Ethyl hexyl oleate:

90 g of commercial 2-ethyl hexyl oleate and 10 g sulfur flour were charged into enclosed flask with nitrogen sparging to sweep of residual byproduct that exists throughout the sulfurization at 185° C. The batch was heated to and maintained at 185° C. for two hours with small exotherms and was cooled to 100° C. to air blow out all residual hydrogen sulfide by product.

Tri-oleates of trimethylolpropane and triethanolamine:

One mole or 285 g oleic acid, one half molar equivalent or 22.3 g (0.167 mole or 0.5 molar equivalent) of trimethylolpropane, and one half molar equivalent or 25 g (0.167 mole or 0.5 molar equivalent) of triethanolamine, were charged together with 0.3% or 1.0 g methane sulfonic acid (MSA) as a catalyst for Fisher esterification. The esterification was carried out at 175° C. under moderate nitrogen gas flow to sweep off water as a by-product until the acid number of about 10-30 mg KOH per gram is reached.

Polypropylene glycol (MW=450) mono-tallate:

225 g (0.5 mole) of polypropylene glycol (MW=450), 285 g (1 mole) of tall-oil fatty acid, and 2.6 g (1 wt.%) methane sulfonic acid catalyst were charged. The esterification was carried out at 175 C under moderate nitrogen gas flow to sweep off water as a by-product until the acid number of about 10-30 mg KOH per gram is reached.

Milliken's Synlube 728:

A commercial emulsifier, di-oleate esters of ethoxylated castor oil, consisting of one mole of castor oil, 25 moles of ethylene oxide and 2 moles of oleic acid.

Testing Methodology

An OFITE EP/Lubricity tester, which is the standard laboratory instrument for determining friction reduction in the field of oil and gas exploration, was used to evaluate friction reduction for the results below in Table I. During conventional use of this test, a hardened steel block rubs against a rotating steel O-ring, rotating at a fixed rate of 60 rpm while being submerged in the drilling fluid. However, a fabricated piece of shale matching the dimensions of the steel block was used in place of the steel block. A load is applied on the shale block and transmitted to the steel ring by applying a constant load of 100-150-200 lbs using a lever arm which “squeezes” the shale block and the rotating steel ring. The torque, measured in in-lbs, was displayed on a digital dial and recorded. A “blank” mud containing no lubricant is run first, followed by separate but otherwise identical mud containing 2.0 wt % of the novel lubricants. Friction reduction is then calculated as the percent of the decrease in torque from the blank to the mud containing the lubricant.

Experiments involving lubricant performance were conducted with a basic formula, similar to that in Table I:

TABLE I
Mud Compositions

| Brine-Based Mud (BBM) Components | grams | |
|---|---|---|
| Actual Bakken ( North Dakota) | 400 | g |
| Brine water | | |
| Rev-Dust (*) | 40 | g |
| Tested Novel Lubricant Blend | 5.0 | g |

(*) Calcium calcium montmorillonite commonly used to simulate effects of reactive drilled solids or cuttings.

TABLE II
150 F AHR Testing Results in Torques
(lb-in) of Novel Lubricants in Brine-Based
Mud (BBM) at 150-200 lb load and 60 RPM:

| | Torque (lb-in) | % Friction Reduction |
|---|---|---|
| BBM Mud | @ 100 lbs-150 | @ 100 lbs-150 |
| Sample | lbs-200 lbs | lbs-200 lbs |
| Blank BBM | 14-22-30 | n/a |
| BBM + 2% | 7-11-15 | 50%-50%-50% |
| Lubricant I | | |
| BBM + 2% | 8-12-16 | 43%-45%-47% |
| Lubricant II | | |

TABLE III
350 F AHR Testing Results in Friction
Reduction % of Novel Lubricants in Brine-Based
Mud (BBM) at 150-200 lb load and 60 RPM:

| BBM Mud | Torque (lb-in) | % Friction Reduction |
|---|---|---|
| Sample | @ 100-150-200 lbs | @ 100-150-200 lbs |
| Blank BBM | 9-15-22 | N/A |
| BBM + 2% | 2-6-9 | 78%-60%-59% |
| Lubricant I | | |
| BBM + 2% | 3-7-11 | 67%-53%-50% |
| Lubricant II | | |

What is claimed is:

1. A composition comprising:
a three-component blend,
wherein the first component is a sulfurized additive;
wherein the second component is an oleic-acid ester or tall-oil fatty-acid ester; and
wherein the third component includes an ethoxylated fatty ester.

2. The composition of claim 1, wherein each component is present within the three-component blend in an amount ranging from 1 to 50% by weight.

3. The composition of claim 1, wherein:
the first component is present within the three-component blend in an amount of about 40% by weight relative to the total weight of the three-component blend;
the second component is present within the three-component blend in an amount of about 30% by weight relative to the total weight of the three-component blend; and
the third component is present within the three-component blend in an amount of about 30% by weight relative to the total weight of the three-component blend.

4. The composition of claim 1, wherein the first component is selected from the group consisting of sulfurized methyl fatty esters, sulfurized 2-ethyl hexyl fatty esters, sulfurized 2-ethyl hexyl oleate, and combinations thereof.

5. The composition of claim 1, wherein the second component is selected from the group consisting of
i. the combination of an oleic-acid ester, a triethanolamine, and a pentaerithrytol;
ii. the combination of a tall-oil fatty-acid ester, a triethanolamine, and a pentaerithrytol;
iii. the combination of an oleic-acid ester, a triethanolamine, and a trimethylolpropane;
iv. the combination of a tall-oil fatty-acid ester, a triethanolamine, and a trimethylolpropane;
v. the combination of an oleic-acid ester, a tris-isopropanolamine, and a pentaerithrytol;
vi. the combination of a tall-oil fatty-acid ester, a tris-isopropanolamine, and a pentaerithrytol;
vii. the combination of an oleic-acid ester, a tris-isopropanolamine, and a trimethylolpropane;
viii. the combination of a tall-oil fatty-acid ester, a tris-isopropanolamine, and a trimethylolpropane;
ix. the combination of an oleic-acid ester, a diethanolamine, and a pentaerithrytol;
x. the combination of a tall-oil fatty-acid ester, a diethanolamine, and a pentaerithrytol;
xi. the combination of an oleic-acid ester, a diethanolamine, and a trimethylolpropane;
xii. the combination of a tall-oil fatty-acid ester, a diethanolamine, and a trimethylolpropane;
xiii. the combination of an oleic-acid ester, a monoethanolamine, and a pentaerithrytol;
xiv. the combination of a tall-oil fatty-acid ester, a monoethanolamine, and a pentaerithrytol;
xv. the combination of an oleic-acid ester, a monoethanolamine, and a trimethylolpropane;
xvi. the combination of a tall-oil fatty-acid ester, a monoethanolamine, and a trimethylolpropane;
xvii. the combination of an oleic-acid ester, a triethanolamine, and a neopentyl glycol;
xviii. the combination of a tall-oil fatty-acid ester, a triethanolamine, and a neopentyl glycol;
xix. the combination of an oleic-acid ester, a triethanolamine, and a glycerine;
xx. the combination of a tall-oil fatty-acid ester, a triethanolamine, and a glycerine;
xxi. the combination of an oleic-acid ester, a tris-isopropanolamine, and a neopentyl glycol;
xxii. the combination of a tall-oil fatty-acid ester, a tris-isopropanolamine, and a neopentyl glycol;
xxiii. the combination of an oleic-acid ester, a tris-isopropanolamine, and a glycerine;
xxiv. the combination of a tall-oil fatty-acid ester, a tris-isopropanolamine, and a glycerine;
xxv. the combination of an oleic-acid ester, a diethanolamine, and a neopentyl glycol;
xxvi. the combination of a tall-oil fatty-acid ester, a diethanolamine, and a neopentyl glycol;
xxvii. the combination of an oleic-acid ester, a diethanolamine, and a glycerine;
xxviii. the combination of a tall-oil fatty-acid ester, a diethanolamine, and a glycerine;
xxix. the combination of an oleic-acid ester, a monoethanolamine, and a neopentyl glycol;
xxx. the combination of a tall-oil fatty-acid ester, a monoethanolamine, and a neopentyl glycol;
xxxi. the combination of an oleic-acid ester, a monoethanolamine, and a glycerine;
xxxii. the combination of a tall-oil fatty-acid ester, a monoethanolamine, and a glycerineSpec xxxiii. the combination of an oleic-acid ester, a triethanolamine, and a di-pentaerythritol;
xxxiv. the combination of a tall-oil fatty-acid ester, a triethanolamine, and a di-pentaerythritol;
xxxv. the combination of an oleic-acid ester, a triethanolamine, and a glycol;
xxxvi. the combination of a tall-oil fatty-acid ester, a triethanolamine, and a glycol;
xxxvii. the combination of an oleic-acid ester, a tris-isopropanolamine, and a di-pentaerythritol;
xxxviii. the combination of a tall-oil fatty-acid ester, a tris-isopropanolamine, and a di-pentaerythritol;
xxxix. the combination of an oleic-acid ester, a tris-isopropanolamine, and a glycol;
xl. the combination of a tall-oil fatty-acid ester, a tris-isopropanolamine, and a glycol;
xli. the combination of an oleic-acid ester, a diethanolamine, and a di-pentaerythritol;
xlii. the combination of a tall-oil fatty-acid ester, a diethanolamine, and a di-pentaerythritol;
xliii. the combination of an oleic-acid ester, a diethanolamine, and a glycol;
xliv. the combination of a tall-oil fatty-acid ester, a diethanolamine, and a glycol;
xlv. the combination of an oleic-acid ester, a monoethanolamine, and a di-pentaerythritol;
xlvi. the combination of a tall-oil fatty-acid ester, a monoethanolamine, and a di-pentaerythritol;
xlvii. the combination of an oleic-acid ester, a monoethanolamine, and a glycol; and
xlviii. the combination of a tall-oil fatty-acid ester, a monoethanolamine, and a glycol.

6. The composition of claim 1, wherein the third component is selected from the group consisting of an ethoxylated fatty ester, a polyethylene glycol ester of oleic acid, a polypropylene glycol ester of tall oil fatty acid, an ethoxylated castor oil di-oleate, and combinations thereof.

7. The composition of claim 4, wherein the first-component fatty esters are oleate fatty esters, tallate fatty esters, castor fatty esters, or combinations thereof.

8. The composition of claim 4, wherein the first component has an amount of sulfur within the first component ranging from 5-20% by weight relative to the total weight of the first component.

9. The composition of claim 1, further comprising:
a liquid-phase aqueous-fluid component.

10. The composition of claim 1, further comprising:
a fluid component selected from the group consisting of sea water, brine, Bakken brine, and produced water generated from oil-gas exploration.

11. A method comprising the step:
using the composition of claim 1 as a lubricant for drilling fluids, coiled-tubing fluids or completion fluids, wherein any of these fluids has brines or heavy brines selected from the group consisting of sea water, brine, Bakken brines, and produced water generated from oil-gas exploration.

12. A composition comprising:
a three-component blend having a pour point of about 5° C.,
wherein the first component is sulfurized methyl oleate that is about 10% sulfur by weight;
wherein the second component is a mixture of tetra-oleates of pentaerythritol and tri-oleates of tri-ethanolamine; and
wherein the third component is polyethylene glycol tallate.

13. The composition of claim 12, wherein the polyethylene glycol tallate is polyethylene glycol (600) tallate.

14. The composition of claim 12,
wherein the first component is present within the blend in an amount that is about 40% by weight relative to the total weight of the three-component blend;
wherein the second component is present within the blend in an amount that is about 30% by weight relative to the total weight of the three-component blend; and
wherein the third component is present within the blend in an amount that is about 30% by weight relative to the total weight of the three-component blend.

15. The composition of claim 12, wherein the pour point of the three-component blend is about 5° Celsius.

16. A method comprising the step:
using the composition of claim 12 as a lubricant for drilling fluids, coiled-tubing fluids or completion fluids, wherein any of these fluids has brines or heavy brines selected from the group consisting of sea water, brine, Bakken brines, and produced water generated from oil-gas exploration.

17. A composition comprising:
a four-component blend,
wherein the first component is sulfurized ethyl hexyl oleate that is about 10% sulfur by weight;
wherein the second component is a mixture of trioleates of trimethylolpropane and tri-ethanolamine;
wherein the third component is polypropylene glycol oleate; and
wherein the fourth component is dioleate esters of ethoxylated castor oil.

18. The composition of claim 17, wherein the polypropylene glycol oleate is polypropylene glycol (430) oleate.

19. The composition of claim 17,
wherein the first component is sulfurized 2-ethyl hexyl oleate that is about 10% sulfur by weight;
wherein the second component is tri-oleates of trimethylolpropane and triethanolamine;
wherein the third component is polypropylene glycol (MW=450) monotallate; and
wherein the fourth component is ethoxylated castor oil esters.

20. The composition of claim 17,
wherein the first component is present within the blend in an amount that is about 40% by weight relative to the total weight of the four-component blend;
wherein the second component is present within the blend in an amount that is about 30% by weight relative to the total weight of the four-component blend;
wherein the third component is present within the blend in an amount that is about 20% by weight relative to the total weight of the four-component blend; and
wherein the fourth component is present within the blend in an amount that is about 10% by weight relative to the total weight of the four-component blend.

21. The composition of claim 17, wherein the pour point of the four-component blend is about −20° Celsius.

22. A method comprising the step:
using the composition of claim 17 as a lubricant for drilling fluids, coiled-tubing fluids or completion fluids, wherein any of these fluids has brines or heavy brines selected from the group consisting of sea water, brine, Bakken brines, and produced water generated from oil-gas exploration.

23. The composition of claim 19,
wherein the first component is present within the blend in an amount that is about 40% by weight relative to the total weight of the four-component blend;
wherein the second component is present within the blend in an amount that is about 30% by weight relative to the total weight of the four-component blend;
wherein the third component is present within the blend in an amount that is about 21% by weight relative to the total weight of the four-component blend; and
wherein the fourth component is present within the blend in an amount that is about 9% by weight relative to the total weight of the four-component blend.
